(19) United States
(12) Patent Application Publication
(10) Pub. No.: US 2009/0066503 A1
(43) Pub. Date: Mar. 12, 2009

(54) System for monitoring containers with seals

(76) Inventor: Lien-Feng Lin, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/987,289

(22) Filed: Nov. 29, 2007

(30) Foreign Application Priority Data
Sep. 7, 2007 (TW) 096133563
Sep. 21, 2007 (TW) 096135554

(51) Int. Cl. G08B 13/00

(52) U.S. Cl. 340/539.13; 340/545.1; 340/568.1

(57) ABSTRACT

A system for monitoring a container includes a seal, a monitoring device and a communication center. The seal is used to lock the doors of the container. The doors can be opened only when the seal is broken or cut illegally. The monitoring device is connected to the seal when the doors are locked by the seal. The monitoring device is disconnected from the seal when the doors are released from the seal. The monitoring device detects the status and position of the seal when the doors are locked by the seal, and sends related data to the communication center so that the communication center can always determine the position of the container and whether the doors have been opened.

### BACKGROUND OF INVENTION

1. Field of Invention

The present invention relates to the Radio Frequency Identification (“RFID”), seals for containers, the Global Positioning System (“GPS”) and wireless communication.

2. Related Prior Art

Taiwanese Patent Application Publication 200538615 discloses a plug-and-socket electronic seal. Taiwanese Patent M257392 discloses a cable-type electronic seal. Taiwanese Patent Application Publication 200614081 and Taiwanese Patents M284729 and M305859 disclose band-type electronic seals. Regardless of the type, each of these electronic seals locks the doors of a container, and includes an RFID chip to store an internal identification (“ID”) code readable by an RFID reader.

Taiwanese Patent Application Publication 200614081 discloses a reader and an emitter disposed in a trailer. The emitter is connected to the reader. The reader is connected to the electronic seal tied on the doors of the container. It mentions that the emitter transmits data read by the reader to a monitoring station or a user's terminal so that the monitoring station or the user's terminal can always know the position of the container. It further mentions that the transmitter may be a car-borne transmitter of the GPS, a personal digital assistant (“PDA”) or a handset of a mobile phone system (such as the GSM). However, the data read by the reader is only related to the internal ID code in the RFID chip in the electronic seal, not related to the position of the electronic seal, and the transmitter only transmits the data read by the reader. Therefore, the transmitter does not transmit any information about the position of the electronic seal to the monitoring station or user's terminal. Obviously, it is focused on the structure of the electronic seal, without giving enough information about how to enable the monitoring station or user's terminal to know the position of the container.

Taiwanese Patent Application Publication 200730413 discloses a method and system for detecting the status of a container. It discloses a reader secured to a door of the container and an electronic seal for locking the door. The point is that the reader includes a reading module, a satellite-based positioning module, a reporting module and a power supply. With the reading module and the satellite-based positioning module, internal ID code in the electronic seal and information about the position of the electronic seal are gained. The reporting module transmits the internal ID code and the position-related information to a distal station. There are however problems worth further study.

Firstly, the reader is secured to the door of the container. That is, each container must be equipped with a reader. Hence, a single reader cannot be used for all of the containers.

Secondly, the reader could be damaged by long hours of exposure to the wind, the sun and the rain since it is always secured to the container between a leaving full container and a home-coming empty container.

Thirdly, the reader consumes much electricity to constantly transmit the internal ID code and the position-related information and cannot work, and this could be mistaken as the breach of the electronic seal.

Fourthly, the distal station cannot actively acquire the status of the electronic seal from the reader since the reader only executes one-way transmission to the distal station.

Fifthly, the reader is not only expensive but also bulky for including a bulky RFID reading module to read the internal ID code from the electronic seal.

Therefore, the present invention is intended to obviate or at least alleviate the problems encountered in prior art.

### SUMMARY OF INVENTION

The primary objective of the present invention is to provide a system for monitoring containers with seals to effectively monitor the status and position of each seal.

According to the present invention, a system includes a seal, a monitoring device and a communication center. The seal is used to lock the doors of a container. The monitoring device includes a shell, a monitoring circuit disposed in the shell, a processing unit, a detection unit, a GPS receiving unit, a communication center and a power supply. The detection unit is connected to the processing unit to detect the status of the seal. The GPS receiving unit is connected to the processing unit to receive and process positioning signals from GPS satellites. The communication center is connected to the processing unit to communication with the communication center. The power supply is connected to all of the foregoing units to provide the electricity needed by the foregoing units. The processing unit is designed to learn the status of the seal through the detection unit and the position of the seal through the GPS receiving unit and transmit the information about the status and/or position to the communication center.

No matter how, the system for monitoring containers with seals of the present invention can effectively monitor the status and/or position and provide related information.

Other objectives, advantages and features of the present invention will be apparent from the following description referring to the attached drawings.

### BRIEF DESCRIPTION OF DRAWINGS

The present invention will be described via the detailed illustration of the preferred embodiment referring to the drawings.

FIG. 1 is an exploded view of a seal and a seal-monitoring device according to the preferred embodiment of the present invention.

FIG. 2 is a side view of the seal and seal-monitoring device shown in FIG. 1.

FIG. 3 is a block diagram of a monitoring circuit used in the seal-monitoring device shown in FIG. 1.

FIG. 4 is an exploded view of a socket of the seal shown in FIG. 1.

FIG. 5 is a cross-sectional view of the socket shown in FIG. 4.

FIG. 6 is another cross-sectional view of the socket shown in FIG. 5.

FIG. 7 is a cross-sectional view of a plug of the seal shown in FIG. 1.

FIG. 8 is a cross-sectional view of the plug shown in FIG. 7 inserted in the socket shown in FIG. 5.

FIG. 9 is a cross-sectional view showing the breach of the seal shown in FIG. 8.

FIG. 10 is a perspective view of the seal-monitoring device shown in FIG. 1.

### DETAILED DESCRIPTION OF EMBODIMENTS

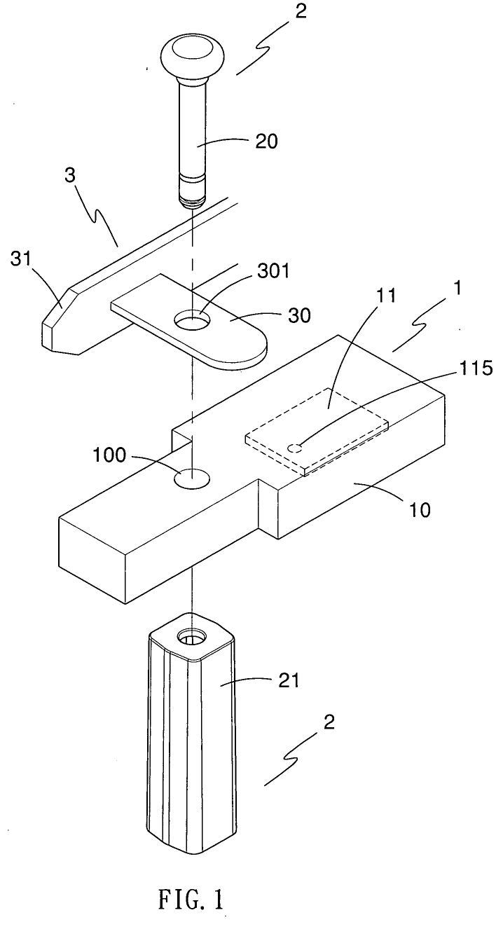

Referring to FIGS. 1 to 3, according to the preferred embodiment of the present invention, a seal-monitoring device 1, a seal 2 and a communication center 5 are provided. The seal 2 includes a plug 20 and a socket 21. The seal-monitoring device 1 includes a shell 10 and a monitoring circuit 11 disposed in the shell 10.

For convenience, the following description of the system according to the present invention will be focused on the delivery of containers; however, the use of the present invention is not limited to the transportation of the containers.

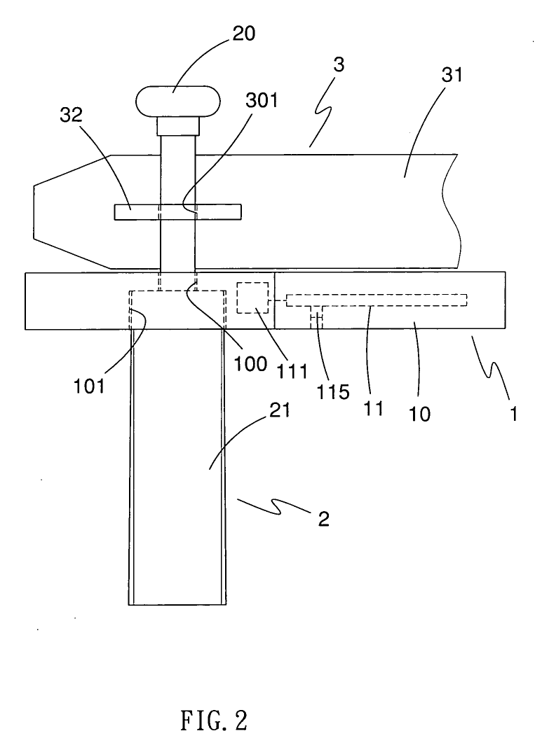

The doors of a container are locked by the seal 2 before the delivery of the container. Specifically, the seal 2 locks the buckling unit 3 of the doors, and the seal-monitoring device 1 monitors the status of the seal 2 as shown in FIG. 2. The seal 2 may be a traditional, mechanical seal or an electronic seal with an RFID chip. The electronic seal may be a passive electronic seal or an active electronic seal with a power supply. The seal 2 may be cable-type, band-type or plug-and-socket-type as shown in FIG. 2. Since an electronic seal generally includes an insert (counterpart of the plug 20) and a socket (counterpart of the socket 21) for receiving the insert, the following description of the seal 2 will be focused on the plug-and-socket-type electronic seal, but the seal 2 is not limited to the plug-and-socket-type electronic seal.

Moreover, the number of the container, the number of a license plate of a trailer for carrying the container, the ID of the driver of the trailer, an external ID code of the seal 2, external and internal ID codes of the seal-monitoring device 1 and the inter-relation of these data are built in a database via a software operating interface before the container sets off. The database may be the database of the dynamic container management system of the customs for example. If the seal 2 is an electronic seal, these data must include an internal ID code. When the container is carried past a control station, these data will be read by a reading system in the control station. For example, an image taking and identifying device may be used to take the number of the license plate of the vehicle and the number of the container, and an RFID reader may be used to read the internal ID code of the electronic seal. Referring to FIGS. 1 and 2, a buckle 31 of a door is engaged with a buckle 30 of another door. The plug 20 of the seal 2 is inserted into the socket 21 of the seal 2 through an aperture 301 defined in the buckle 30 and an aperture 100 defined in a shell 10 of the seal-monitoring device 1. Now, the seal 2 is connected to the seal-monitoring device 1 as shown in FIG. 2. Via the aperture 100, the seal-monitoring device 1 is connected to the seal 2 when the doors are locked by the seal 2, and the seal-monitoring device 1 is disconnected from the seal 2 when the seal 2 is torn.

Once inserted in the socket 21, the plug 20 is detained by a detaining device (to be described later) in the socket 21. Now, the seal 2 is normal. Therefore, the buckle 31 cannot be disengaged from the buckle 30 unless the plug 20 is cut or torn. That is, the doors of the container cannot be opened unless the owner of the goods in the container agrees to cut or torn the plug 20. Now, the container is normal, not intruded. If the doors are opened, the plug 20 of the seal 2 must have been cut or torn illegally. By now, the seal 2 has been turned into an abnormal status from the normal status. That is, the container has been intruded and is in an abnormal status. The seal-monitoring device 1 can detect and report this change to the communication center 5 wirelessly.

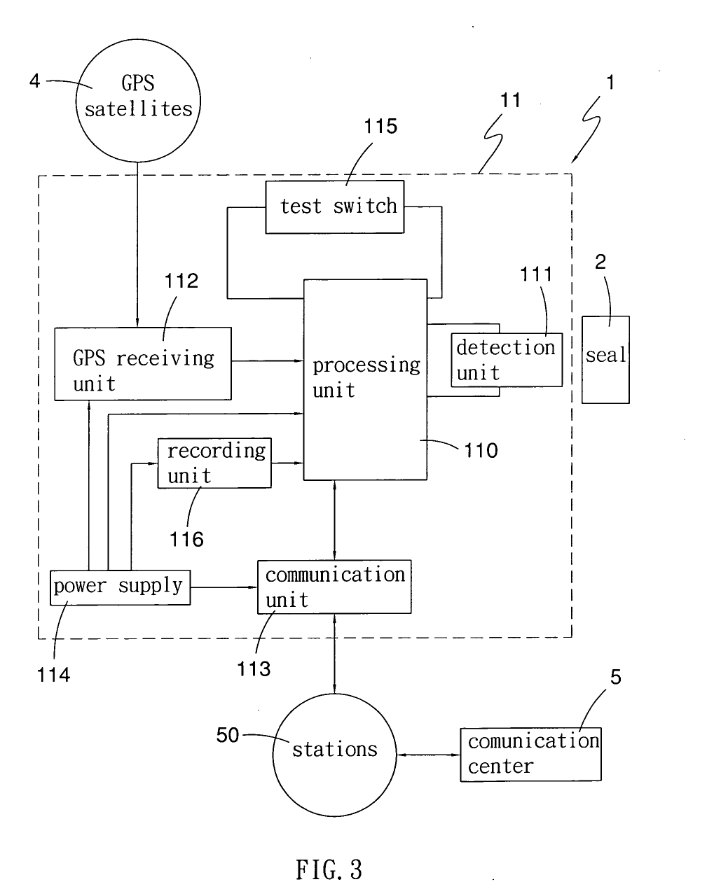

Referring to FIG. 3, the monitoring circuit 11 in the seal-monitoring device 1 communicates with the communication center 5 through one or more stations 50, and communicates with GPS satellites 4. The GPS satellites 4 are responsible for transmitting positioning signals. The communication center 5 may be a PDA, a mobile phone or computer. The communication center 5 is preferably a mobile phone such as a GPS cell phone so that the monitoring circuit 11 communicates with the communication center 5 through the GSM stations of the GSM in the form of news briefs.

Referring to FIG. 3, the monitoring circuit 11 includes a processing unit 110, a detection unit 111 connected to the processing unit 110, a GPS receiving unit 112 connected to the processing unit 110, a communication unit 113 connected to the processing unit 110 and a power supply 114 connected to all of the foregoing elements. If needed, the monitoring circuit 11 may include a recording unit 116 connected to the power supply 14.

The detection unit 111 may be a photoelectric switch, a spring-biased switch, a micro-switch or a reed switch. When the plug 20 of the seal 2 is cut or torn, the switch detects it and changes the electric status, i.e., from a high-voltage signal representing the ON status to a low-voltage signal representing the OFF status, or from a low-voltage signal representing the OFF status to a high-voltage signal representing the ON status. For example, if a photo breaker is used as the detection unit 111, the photo breaker will be provided on the wall of the aperture 100. When the plug 20 of the seal 2 is inserted in the socket 21 through the aperture 100 as shown in FIGS. 1 and 2, light emitted from the photo breaker will be blocked. The photo breaker is in the OFF status for sending the low-voltage signal to the processing unit 110. That is, the seal 2 is in the normal status. If the plug 20 is cut or torn or taken away from the aperture 301 of the buckle 30, the light emitted from the photo breaker will not be blocked. The photo breaker is in the ON status for sending the high-voltage signal to the processing unit 110. That is, the seal 2 is in the abnormal status. Hence, from the change in the electric status of the seal-detection unit 111, it can be learned whether the seal 2 is in the normal or abnormal status.

Alternatively, if a reed switch is used as the detection unit 111, a magnet must be provided on the seal 2. Thus, the magnetic force on the reed switch by the magnet is strong to turn the reed switch into the ON status when the doors are locked by the seal 2. On the contrary, the magnetic force on the reed switch by the magnet is week to turn the reed switch into the OFF status when the doors are released from the seal 2.

Never matter what element is used as the detection unit 111, the seal-monitoring device 1 can detect the normal status of the seal 2 when the doors are locked by the seal 2, and can detect the abnormal status of the seal 2 when the doors are released from the seal 2.

The GPS receiving unit 112 may be an AC-1513 GPS module (with an ANTARISTM™ chip set by the Atmel Company) or SC-1513 GPS module (with a SiRF Star III chip by THE SIRF) provided by the LOCOSYS Technology Company or a MSB2112 GPS module provided by the MStar Company. No matter what, the GPS receiving unit 112 can receive and process the positioning signals from the GPS satellites 4 to provide GPS data. The GPS data include but not limited to time and a coordinate. From the time and the coordinate, the time and the position of the GPS receiving unit 112 can be known. That is, the seal-monitoring device 1 can detect the position of the seal 2 when the doors are locked by the seal 2. The position of the seal 2 at a point of time is detected according to the GPS in this embodiment; however, the position of the seal 2 at a point of time can be detected in any other appropriate manner.

The communication unit 113 communicates with the communication center 5. Preferably, the communication unit 113 communicates with the communication center 5 through the stations 50. If the mobile communication system is a GSM mobile communication system, the communication unit 113 must be a GSM communication module so that the communication unit 113 can communicate with the communication center 5 in the form of news briefs for example. The primary advantage of the communication via the stations 50 of the communication system is that although the communication center 5 may not be able to receive the news briefs from the communication unit 113 because it is turned off or interfered with, the communication center 5 can receive the news briefs from nearby stations 50 once the problems are solved. Moreover, the communication unit 113 can receive a response from the communication center 5 via the nearby stations 50 once the problems are solved. The communication unit 113 may be a GSM communication module often used in a mobile phone such as a GR47/48 module provided by the Sony-Ericsson Company.

The processing unit 110 may be any proper microprocessor equipped with proper circuits (such as memories) and software programs. No matter what, the processing unit 110 must be able to receive and process the signals from the detection unit 111 and the GPS data from the GPS receiving unit 112 and actuate the communication unit 113 to transmit status-related data to the communication center 5. The status-related data include the position and status of the seal 2 at a point of time. The communication unit 13 sends news briefs to the communication center 5 via the stations 50. A news brief includes the status-related data.

The recording unit 116 is used to record voice and/or images, and may be any ordinary digital voice/image-recording circuit or module. People, things and scenes near the seal 2 can be recorded by the recording unit 116. If the recording unit 116 can detects the temperature and humidity, the weather around the seal 2 can be recorded too. The recorded data will be collected and stored in a memory of the recording unit 116 or a memory of the processing unit 110. Furthermore, the communication unit 113 can sends these data to the communication center 5 under the control of the processing unit 110, i.e., integrated with the status-related data. Thus, the communication center 5 not only knows the status and position of the seal 2 but also the environment around the seal 2. For example, when a person is trying to break the seal 2, the recording unit 116 will record the process, and the communication unit 113 will transmits the process to the communication center 5.

The power supply 114 may be a power supply circuit including a battery, a power supply circuit including a rechargeable battery or capacitor and a charging and recharging circuit (including a protective circuit) or a power supply circuit including a solar cell, a photovoltaic unit and a charging and recharging circuit (including a protective circuit). No matter what, the power supply 114 provides electricity to all of the foregoing elements.

As discussed above, the seal-monitoring device 1 can provide the status-related data to the communication center 5. The status-related data include the status and position of the seal 2 at a point of time and even the status of the environment around the seal 2 (the voice and/or images of people and/or things, the weather, temperature and/or humidity of the environment). The seal-monitoring device 1 is attached to the seal 2, and the seal 2 is attached to the container. The status-related data hence represents the status and position of and the environment around the container. Therefore, during the delivery of the container, the owner of the container or controlling person can know the status and position of and the environment around the container because the seal-monitoring device 1 sends the status-related data to the communication center 5. That is, once the container is intruded or in danger, the seal-monitoring device 1 can provide information about the dangerous situation to the communication center 5 to notify the owner or controlling person of the dangerous situation so that the owner or controlling person can take countering actions.

Preferably, the processing unit 110 instructs the communication unit 113 to send the status-related data periodically. The processing unit 110 instructs the communication unit 113 to transmit the status-related data every several seconds for example. When not sending the status-related data, the communication unit 113 is in a standby status, consuming a little electricity. Furthermore, the processing unit 110 may change the time interval between two sending activities on receiving a communication time-changing order from the communication center 5.

Preferably, the processing unit 110 instructs the GPS receiving unit 112 to receive the positioning signals from the GPS satellites 4 at a predetermined time interval. For example, the processing unit 110 instructs the GPS receiving unit 112 to receive the positioning signals from the GPS satellites 4 every several seconds. While not receiving the positioning signals, the GPS receiving unit 112 is in a standby/sleep status, consuming a little electricity. Thus, the consumption of electricity from the power supply 114 is reduced. Furthermore, the processing unit 110 may be able to change the time interval between two receiving activities on receiving a communication time-changing order from the communication center 5.

Preferably, the processing unit 110 receives an inquiring order from the communication center 5 and instructs the communication unit 113 to send the status-related data. Therefore, the owner or controlling person can actively inquire the status and position of the seal 2.

Preferably, the processing unit 110 monitors the energy in the power supply 114 and instructs the communication unit 113 to send a warning signal to the communication center 5 when the energy in the power supply 114 is lower than a predetermined value. Thus, the chance that the communication center 5 makes mistakes in monitoring the container is reduced.

Preferably, the processing unit 110 counts the number of times for which the plug 20 is inserted in the socket 21 via the detection unit 111, and sends the number of times and the status-related data to the communication unit 113. As described above in relation to the detection unit 111, every time the plug 20 of the seal 2 is inserted through the aperture 100 of the seal-monitoring device 1, the electric status of the detection unit 111 is changed, and the number of times is increased by 1. When the plug 20 is inserted in the socket 21 as shown in FIG. 2, the processing unit 110 starts to count from an initial number n (n is an integral number no smaller than 0). The resultant number of times in the processing unit 110 is n+1. Every time the communication unit 113 sends the status-related data, the processing unit 110 sends the number of times to the communication center 5. Therefore, the owner or controlling person of the container not only can learn the status and position of the container from the status-related data but also whether the plug 20 has been pulled from and inserted in the socket 21 again from the number of times. In the foregoing embodiment, if the owner or controlling person receives n+1 as the number of times, the plug 20 must have not been pulled from and inserted in the socket 21 again. If the owner or controlling person receives n+2 as the number of times, the plug 20 must have been pulled from and inserted in the socket 21 again. That is, the container could have been intruded. The owner or controlling person should take countering actions immediately.

The seal 2 may be design for repeated use. That is, the plug 20 can be inserted in and pulled from the socket 21 for many times.

Preferably, the processing unit 111 turns off or switches the GPS receiving unit 112 and/or the communication unit 113 into the standby status after the processing unit 111 transmits the status-related data to the communication center 113.

Preferably, as shown in FIGS. 1 through 3, the monitoring circuit 11 includes a test switch 115 connected to the processing unit 110. On receiving a signal from the test switch 115, the processing unit 110 sends a test signal to the communication unit 113 to make the communication unit 113 send the status-related data to the communication center 5. The test signal is generated when the test switch 115 is pushed. The status-related data indicates the position and test status of the GPS receiving unit 112 when the test switch 115 is pushed. Similarly, the communication unit 113 transmits a news brief to the communication center 5 via the stations 50 of the mobile communication system. The news brief includes the status-related data. For using the test switch 115, it can be determined whether the monitoring circuit 11 is normal or not before the use.

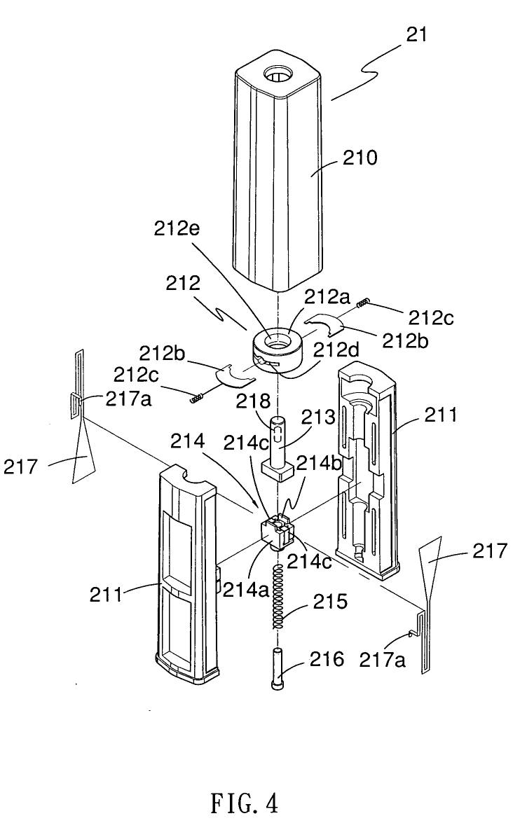

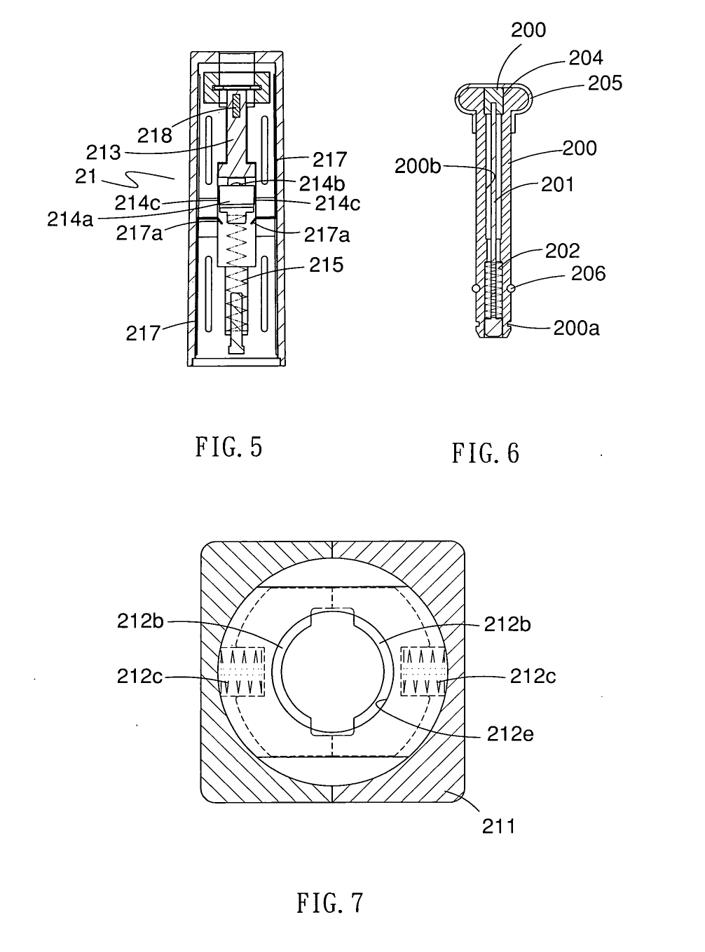

Referring to FIGS. 4 and 5, the preferred embodiment of the plug 21 of the seal 2 is shown. The plug 21 includes a shell 210, two halves 211, a restraining device 212, an RFID unit 214 and an antenna unit. The antenna unit includes two antennas 217. The halves 211 are joined together to contain the foregoing elements. The restraining device 212 includes a metal ring 212a, two tabs 212b and two springs 212c. The metal inr 212a includes two opposite slots 212d and an aperture 212e. Each of the slots 212d receives a related one of the tabs 212b and a related one of the springs 212c. The aperture 212e is just big enough to receive the plug 20. The RFID unit 214 includes a movable rod 213, a movable block 214a, a RFID chip 214b for storing an internal ID code, a first spring 215 and a rod 216. The movable rod 213 is located between the restraining device 212 and the movable block 214a. A magnet 218 is disposed in an end of the movable rod 213. The movable block 214a is abutted against the first spring 215. The RFID chip 214b is secured to the movable block 214a. Two legs of the RFID chip 214b are extended from two opposite sides of the movable block 214a. In this embodiment, each of the antennas 21 includes a leg 217a inserted into the halves 211. The rod 216 is securely disposed in the halves 211. The spring 215 is mounted on the rod 216 so that the spring 215 will not be bent.

Referring to FIG. 5, there is shown the socket 21 not receiving the plug 20. The magnet 218 is in position #1 together with the movable rod 213. The RFID chip 214b is in position #2 together with the movable block 214a. It should be noted that the legs 214c of the RFID chip 214b are not in contact with the legs 217a of the antennas 217 at this moment. Therefore, the RFID chip 214b cannot effectively transmits an RF signal including the internal ID code through the antennas 217. At most, the RFID chip 214b transmits a very week signal. That is, a corresponding RFID reader cannot read the internal ID code from the RFID chip 214b.

Referring to FIG. 6, the restraining device 212 is shown. Each of the tabs 212b is abutted against a related one of the springs 212c so that a portion thereof is inserted in the aperture 212e.

Referring to FIG. 7, there is shown the preferred embodiment of the plug 20. The plug 20 includes a metal shell 200, a metal rod 201 and a second spring 202. The metal shell 200 includes an enlarged head at an upper end, a groove 200a in a lower end and a tunnel 200b extending throughout its length. The metal rod 201 is entirely inserted in the tunnel 200b of the metal shell 200. An upper end of the metal rod 201 is securely disposed in the head of the metal shell 200. A lower end of the metal rod 201 is located in the lower end of the metal shell 200. The second spring 202 is mounted on the metal rod 201, and is compressed and therefore loaded. The metal shell 200 and the metal rod 201 are made of metal that cannot easily be cut. Alternatively, the may be made of any other strong material. The metal rod 201 includes, at the lower end, an enlarged head for supporting the second spring 202. The metal rod 201 includes, at the upper end, a thread 203 engaged with a metal nut 203 disposed in a space 204 in the head of the shell 200. By exerting an upward force on the lower end of the metal rod 201, the upper end of the metal rod 201 is moved from the space 204 so that it can conveniently be engaged with the metal nut 203. When the upward force is stopped, the metal nut 203 will sink into the space 204. Then, a coat 205 made of rubber is provided on the head of the metal shell 200. Moreover, a water-proof 206 ring 206 is mounted on the metal shell 200.

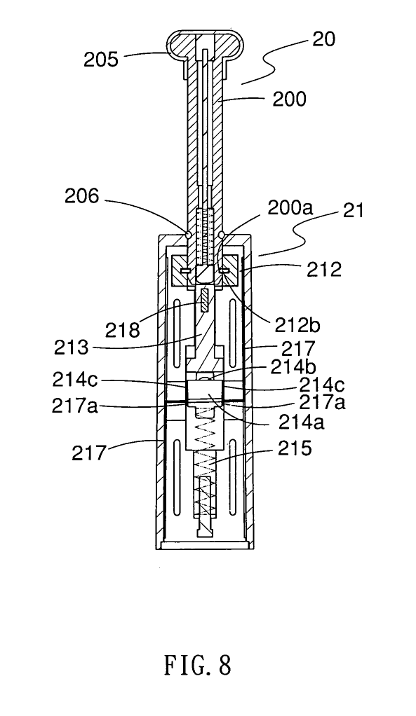

Referring to FIG. 8, the plug 20 is inserted in the socket 21. During the insertion of the plug 20 through the aperture 212e of the tabs 212b of the restraining device 212, the tabs 212b are made to retreat a little bit by the metal shell 200 at first. Then, they are inserted into the groove 200a of the metal shell 200 so that the plug 20 cannot be pulled from the socket 21. Simultaneously, the movable rod 213 is moved a little by the plug 20 so that the movable block 214a is moved for a same distance by the movable rod 213. The magnet 218 is moved from position #1 to position #1-1 together with the movable rod 21. The RFID chip 214b is moved from position #1 to position #2-1 together with the movable block 214a. At this moment, the legs 214c of the RFID chip 214b are in contact with the legs 217a of the antennas 217. Therefore, the RFID chip 214b is in the standby status. That is, the RFID chip 214b can effective the RF signal including the internal ID code through the antennas 217, and the corresponding RFID reader can read the internal ID code from the RFID chip 214b. Moreover, the first spring 215 is compressed a little because of the movement of the movable block 214a.

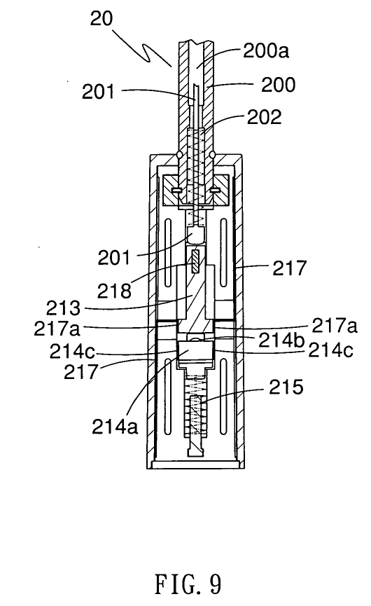

Referring to FIG. 9, the plug 20 is inserted in the socket 21; however, the plug 20 is cut. Now, the metal rod 201 of the plug 20 is cut and disengaged from the shell 200. Furthermore, the metal rod 201 is ejected from the tunnel 200a of the metal rod 201 by the second spring 202. The movable rod 213 is moved a little so that the movable block 14a is moved a same distance. Thus, the magnet 218 is moved from position #1-1 to position #1-2 together with the movable rod 213, and the RFID chip 214b is moved from position #2-1 to position #2-2 together with the movable block 214a. Now, the legs 214c of the RFID chip 214b are not in contact with the legs 217a of the antennas 217 so that the RFID chip 214b cannot effectively transmits the RF signal through the antennas 217. The second spring 202 is loaded more than the first spring 215 so that the cut metal rod 201 can smoothly be ejected.

The magnet 218 disposed in the seal 2 is used to cooperate with the detection unit 111 of the seal-monitoring device 1. The detection unit 111 is a reed switch. The magnet 218 exerts enough magnetic force to affect the reed switch, i.e., to turn the detection unit 111 between the ON and OFF statuses. When the magnet 218 is close to the reed switch 111, the reed switch 111 feels strong magnetic force and enters the ON status. When the magnet 218 is far from the reed switch 111, the reed switch 111 feels weak magnet force and enters the OFF status.

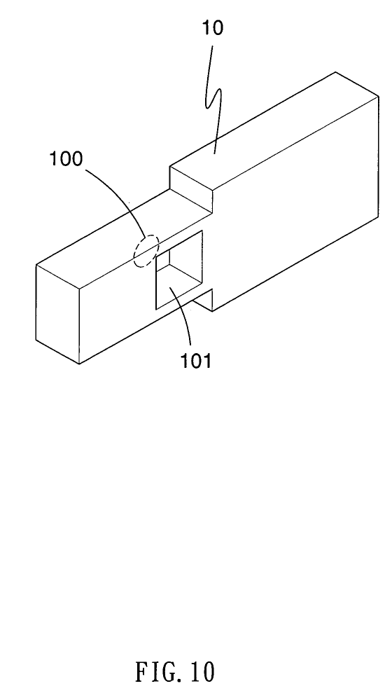

In this embodiment, when the plug 20 is inserted into the socket 21, the magnet 218 in the socket 21 exerts enough magnetic force to affect the reed switch 111 although it is moved a little. To keep the magnet 218 as close to the reed switch as possible as shown in FIG. 10, the shell 10 includes an aperture 101 in communication with the aperture 100. The aperture 101 is larger than the aperture 100. The aperture 101 can receive a portion of the plug 21 as shown in FIG. 2.

No matter how, when the plug 20 is inserted in the socket 21, the reed switch 111 in the shell 10 is affected by the magnetic force exerted by the magnet 218 in the socket 21 and is in the ON status. When the plug 20 is cut, the magnet 218 will be moved to position #1-2 together with the movable rod 213. Now, the magnet 218 is far from the reed switch 111 in the shell 10 so that the reed switch 111 is not affected by the magnetic force exerted by the magnet 218 and is in the OFF status. Therefore, according to the change in the electric status of the reed switch 111, the processing unit 110 of the monitoring circuit 11 can determine the status of the seal 2.

Referring to FIG. 8, an upper end of the antenna 217 on the right is close to the restraining device 212. The antennal 217 is a flat antenna, and the upper end thereof is separated from the metal ring 212a by a small gap. Where the plug 20 is simply inserted in the socket 21, the size of the gap does not matter. However, where the plug 20 is used as an antenna, the size of the gap must be carefully calculated.

There are at least two methods to use the plug 20 as an antenna. The first method is to connect the antenna 217 to the metal ring 212a. The second method is to locate the antenna very close to the metal ring 212a as shown in FIG. 8 so that there is a coupling relation. In the second method, the metal ring 212a and the plug 20 are used as part of the antenna unit of the seal 2 so that the RF signal is transmitted through the antennas 217 and the plug 20. Where, the plug 20 is used as an antenna, the antennas 217 can be short. That is, the socket 21 can be short and occupy only a little space. Where the seal 2 is an active electronic seal equipped with a power supply, the structure thereof will be like the above-mentioned one; however, there must be a first wireless communication module connected to the RFID chip to send the internal ID code in the RFID chip and a second wireless communication module to receive the internal ID code from the first wireless communication module. As discussed in relation to the foregoing embodiment, when the plug 20 of the seal 2 is cut, the RFID chip will be moved from the legs of the antennas so that the first wireless communication module cannot send the internal ID code to the second wireless communication module. The processing unit 110 of the monitoring circuit 11 determines the status of the seal 2 based on whether the second wireless communication module receives the internal ID code from the first wireless communication module or not.

As discussed above, the seal-monitoring device 1 can report the status and position of the container and the environment around the container. Moreover, the seal-monitoring device 1 is combined with the seal 2, not secured to the container so that the seal-monitoring device 1 can be separated from the seal 2 when the seal 2 is cut when the container is received legally. Then, the seal-monitoring device 1 can be returned by the express, without having to be subjected to the sun, the wind and the rain as it would be if secured to the container.

Moreover, in these embodiments, the seal-monitoring device 1 does not have to read the internal ID code from the RFID chip 214b in the seal 2 at all. Therefore, the seal-monitoring device 1 does not include and does not need an RFID reading module. That is, the cost is reduced and so is the size.

The present invention has been described via the detailed illustration of the embodiments. Those skilled in the art can derive variations from the embodiments without departing from the scope of the present invention. Therefore, the embodiments shall not limit the scope of the present invention defined in the claims.

1. An apparatus for monitoring a container with a seal, the apparatus comprising a shell and a monitoring circuit disposed in the shell and formed with:
a processing unit;
a detection unit connected to the processing unit to detect the status of the seal;
a GPS receiving unit connected to the processing unit to receive and process positioning signals from GPS satellites;
a communication unit connected to the processing unit to communicate with a communication center; and
a power supply connected to the units to provide electricity needed by the units;
wherein the processing unit detects the status of the seal via the detection unit, detects the position of the seal via the GPS receiving unit, and sends status-related data including the status and position of the seal to the communication center via the communication unit.

2. The apparatus according to claim 1, wherein the shell is attached to the seal in a detachable manner.

3. The apparatus according to claim 2, wherein the detection unit detects the seal and causes the power supply to provide the electricity on detecting the seal when the shell is attached to the seal.

4. The apparatus according to claim 1, wherein the processing unit transmits the status-related data periodically after a time interval.

5. The apparatus according to claim 4, wherein the processing unit changes the time interval on receiving a communication time-changing order from the communication center.

6. The apparatus according to claim 1, wherein the GPS receiving unit can enter a SLEEP status where it stops receiving the positioning signals from the GPS satellites, and the processing unit wakes up the GPS receiving unit to receive the positioning signals from the GPS satellites periodically after a time interval.

7. The apparatus according to claim 6, wherein the processing unit changes the time internal between two receiving activities on receiving a receiving time-changing order from the communication center.

8. The apparatus according to claim 1, wherein the processing unit sends the status-related information via the communication unit on receiving an inquiry order from the communication center.

9. The apparatus according to claim 1, wherein the processing unit monitors the electricity in the power supply and sends a warning signal of low capacity via the communication unit on determining that the electricity in the power supply is lower than a predetermined value.

10. The apparatus according to claim 1, wherein the shell comprises an aperture to receive the seal.

11. The apparatus according to claim 1, wherein the detection unit is a wireless communication module for receiving an internal code from the seal.

12. The apparatus according to claim 1, wherein the detection unit is selected from a group consisting of a photoelectric switch, a spring-biased switch, a micro-switch and a reed switch.

13. The apparatus according to claim 1, wherein the monitoring circuit comprises a recording unit connected to the processing unit and energized by the power supply to record data about the environment around the seal, and the processing unit sends the data recorded by the recording unit to the communication center via the communication unit.

14. A system for monitoring a container with two doors, the system comprising:
a seal for locking the doors of the container;
a monitoring device for connection to the seal when the doors of the container are locked by the seal; and
a communication center for communicating with the monitoring device;
wherein the monitoring device detects the status and position of the seal and sends related data to the communication center.

15. The system according to claim 14, wherein the monitoring device monitors the environment around the seal.

16. A seal comprising a plug and a socket, wherein:
the socket comprises a restraining device, an RFID unit and an antenna unit, and the restraining device is disposed in the socket to restrain the plug and, on the other hand, pushed into electric contact with the antenna unit by the plug when the plug is inserted to a predetermined position in the socket; and
the plug comprises a metal shell and a rod inserted in the metal shell, and when the metal shell and the rod are cut together, the cut rod will be ejected from the metal shell and push the RFID unit from the antenna unit.

17. The system according to claim 16, wherein the antenna unit comprises two antennas, and one of the antennas comprises an upper end located close to the restraining device to form an effective coupling relation between them.

18. A seal comprising a plug and a socket, wherein the socket comprises a restraining device, an RFID unit and an antenna unit, wherein:
the restraining device is disposed in the socket to restrain the plug when the plug is inserted to a predetermined position in the socket;
the RFID unit is movably disposed in the socket and pushed into electric contact with the antenna unit by the plug when the plug is inserted to a predetermined position in the socket; and
the antenna unit comprises two antennas, and one of the antennas comprises an upper end located close to the restraining device for forming an effective coupling relation between them.
